(19) United States
(12) Patent Application Publication
(10) Pub. No.: US 2026/0340598 A1
(43) Pub. Date: Oct. 29, 2026

(54) Artificial Intelligence System in the form of a digital application (desktop and mobile) for Athlete Recruitment, Performance Analysis, and User Engagement in a Digital Platform

(71) Applicants: Amit Somen, Novi, MI (US); Casey J Wakula, Novi, MI (US); Michael Helms, Novi, MI (US)

(72) Inventors: Amit Somen, Novi, MI (US); Casey J Wakula, Novi, MI (US); Michael Helms, Novi, MI (US)

(21) Appl. No.: 19/192,370

(22) Filed: Apr. 29, 2025

Related U.S. Application Data
(60) Provisional application No. 63/702,338, filed on Oct. 2, 2024.

(51) Int. Cl. G06Q 10/40

(52) U.S. Cl. CPC G06Q 10/40

(57) ABSTRACT

A system and method for facilitating secure profile creation, discovery, and interaction among athletes, coaches, institutions, and brand-affiliated entities within a digital athletic platform. The system supports role-based user registration, structured profile data entry, multimedia content sharing, and age-gated access controls for users. Athlete users may upload performance metrics, videos, and personal attributes, while coach and institutional users may define recruitment criteria and program characteristics. A content interaction layer enables users to post and engage with video and written content through likes, comments, and follows. Discovery and search are conducted via structured filters, with rule-based recommendation features that surface relevant users or content based on declared interests and engagement history. All user activity is governed by permissions, audit trails, and moderation safeguards, ensuring a transparent, compliant, and scalable environment for digital recruitment, athletic networking, and brand engagement. The system is configured for tiers of features at various price points.

### BACKGROUND OF THE INVENTION

### Field of Invention

The present invention relates generally to digital networking systems within the athletic domain and, more specifically, to a platform that facilitates secure profile creation, targeted discovery, and connection among athletes, coaches, institutions, and commercial entities. The invention provides mechanisms for user-generated content sharing, including video and statistical information, and enables curated discovery through basic algorithmic assistance. Additionally, the invention addresses regulatory and safety considerations for minors by incorporating parent-mediated registration processes for users under a designated age threshold. The system enables members of the athletic community to connect, communicate, and showcase athletic attributes in a centralized, profile-based environment optimized for recruitment, brand exposure, and community engagement.

### BRIEF SUMMARY OF THE INVENTION

The present invention provides a digital platform designed to facilitate connection, discovery, and collaboration among athletes, coaches, educational institutions, and athletic brands. The system enables users to create customized profiles showcasing athletic attributes, including statistics, position preferences, highlight videos, and schools or programs of interest. The platform incorporates tailored onboarding flows for different user types—athletes, coaches, schools, retailers, and trainers—ensuring that each stakeholder can present relevant information and engage with the appropriate audience. For users below a defined age threshold, such as athletes under the age of 14, the system requires parent-or guardian-mediated account creation to comply with regulatory and ethical standards regarding youth privacy and data sharing. The data sharing can be only specific to public profiles.

The platform further enables users to post and interact with multimedia content, including videos and images, and provides mechanisms for likes, comments, and visibility based on profile attributes and activity. A lightweight algorithmic recommendation system surfaces relevant users and content based on input parameters such as sport type, geographic region, and expressed interests, facilitating organic discovery without full-scale automation. Coaches may query the platform using structured filters to identify athletes matching specific program needs. The system is structured to promote transparent, safe, and authentic engagement within the athletic community and to streamline the recruitment and networking process without reliance on speculative or unproven artificial intelligence technologies.

### BRIEF DESCRIPTION OF THE FIGURES

FIG. 1 illustrates a seven-step system flow encompassing user role registration (FIG. 1.101), age-gated profile creation (FIG. 1.103), structured data and media upload (FIG. 1.105), content publication (FIG. 1.107), user engagement (FIG. 1.109), filtered discovery (FIG. 1.111), and optional algorithmic surfacing based on profile and engagement similarity (FIG. 1.113).

### DETAILED DESCRIPTION

The present invention discloses a multi-user digital platform configured to facilitate secure, role-specific interaction among participants within the broader athletic ecosystem. The system is architected as a modular web-based and mobile-accessible environment, wherein users assume distinct operational roles, including but not limited to: (i) athlete users, (ii) coach and recruiter users, (iii) institutional representatives, and (iv) commercial brand affiliates such as athletic retailers, trainers, and nutrition specialists. Each role is instantiated via a differentiated registration protocol and access control layer, such that the system maintains distinct data models, permissions schemas, and user interface (UI) presentations based on the authenticated user type.

At its core, the system comprises a centralized backend infrastructure built atop scalable cloud-based services, including structured databases for user profile metadata, media asset storage systems for user-submitted video and image content, and a role-based access control (RBAC) engine for content visibility and interaction logic. Upon initial user interaction, a profile creation module is invoked, capturing structured profile fields specific to the user category selected. For athlete users, the platform solicits demographic details, sport-specific attributes, self-reported statistics, positions of interest, affiliated programs or schools, and optionally, highlight media uploads. For coach or recruiter users, the platform offers institution-affiliated profile creation, including fields related to program size, division, academic profile, scholarship availability, and geographic recruiting range. For brand affiliates, the platform facilitates business-oriented account creation, optimized for outreach, targeted discovery, and marketing engagement with athlete users.

Each user's system interaction is governed by backend logic rules that enforce data segmentation, privilege hierarchies, and privacy controls, ensuring that user-specific data—such as athlete performance metrics or school affiliation—is viewable only by appropriate counterparties based on mutual visibility conditions or explicit consent triggers. The UI renders dynamic components such as dashboards, profile views, connection prompts, and content feeds, all governed by role-aware data filtering mechanisms. Although artificial intelligence (AI) is not deployed at this layer for autonomous decision-making, limited procedural logic is employed for user interface customization and feature availability toggles based on metadata associated with the user type.

The system further incorporates a data normalization sublayer that standardizes profile content into indexed formats suitable for downstream retrieval, matching, and recommendation processes. This includes converting self-reported statistics into validated numerical fields, structuring uploaded media for compatibility with the platform's media management subsystem, and encoding preference inputs for query optimization. While this normalization logic is primarily deterministic, select modules may optionally apply lightweight AI-based classifiers—such as basic text categorization models—to assist in tagging content types or sport-specific interests for future discoverability. Such AI-assisted processes are governed by strict rule-based boundaries to ensure transparency, interpretability, and compliance with the platform's low-latency requirements and user privacy mandates.

From a systems integration perspective, the platform's architecture is extensible, allowing for the modular addition of future functional units—such as recommendation engines, ranking systems, or analytics dashboards—without requiring fundamental changes to the core data models or authentication frameworks. This modular design principle ensures long-term scalability and adaptability across evolving use cases, while maintaining system integrity and minimizing disruption to core user experiences. All system components are constructed in accordance with best practices in distributed system design, data encryption, and user session management, ensuring robustness, resilience, and regulatory compliance in multi-jurisdictional deployment environments.

The present invention incorporates a robust, compliance-oriented registration framework designed to enforce secure, verifiable profile creation across multiple user categories, with specific provisions for users falling below a designated age threshold. The registration process is governed by a layered authentication and validation protocol, wherein distinct workflows are initiated based on the classification of the user at the time of onboarding. The system supports differentiated entry paths for athlete users, coaching staff, academic institutions, and commercial brand entities, with each entry point associated with unique required disclosures and system permissions.

For athlete users, the system enforces a structured intake process requiring submission of personal identifiers, sport affiliation, self-reported performance data, and optional multimedia assets, such as video footage or photographic evidence of athletic achievements. During this process, the platform performs internal validation checks to prevent duplication of profiles and verify logical coherence among submitted data fields (e.g., physical statistics within plausible athletic ranges). Athlete users are also required to attest to the authenticity of any submitted metrics via a digitally acknowledged honor code, the language of which is maintained in the platform's legal compliance registry. The honor code serves both as a self-attestation of accuracy and as a basis for platform-administered audits, should statistical anomalies or disputes arise.

In adherence to child protection statutes such as the Children's Online Privacy Protection Act (COPPA) in the United States and similar jurisdictional standards globally, the invention integrates an age-gating subsystem configured to detect when a prospective athlete user is under a defined age threshold, which in one embodiment is set at fourteen (14) years. Upon detection of an underage user input during the onboarding sequence, the system conditionally initiates a co-creation protocol wherein account registration is suspended until a parent or legal guardian consents to and completes the verification process. This co-creation workflow comprises a distinct UI and a separate authentication pipeline, wherein the guardian must submit identifying credentials, review the terms of data collection and usage, and digitally authorize the creation of the child's profile. Upon successful authorization, the parent-linked account gains oversight privileges, including content visibility, messaging restrictions, and the right to edit or deactivate the minor's profile.

To enhance data integrity and regulatory compliance, the system employs verification safeguards throughout the onboarding process. These include email verification links, IP and device fingerprinting for fraud prevention, and optional two-factor authentication (2FA) for users seeking advanced control over account access. Institutional and commercial users may be subject to a different set of validations, including domain-specific email verification (e.g., “.edu” for schools) or commercial business registration lookups to verify brand authenticity. All user information collected during onboarding is processed in accordance with applicable data privacy regulations and stored in encrypted form within the system's secure database architecture.

Moreover, the invention provides internal administrative tools for platform moderators and compliance officers to monitor registration trends, detect anomalies, and manually intervene in the case of suspected policy violations or fraudulent account creation. This administrative backend includes dashboards for flagging accounts by risk score, which may be computed based on heuristic rules (e.g., excessive activity during onboarding, repeated failed verifications, duplicate biometric submissions) rather than opaque machine learning outputs, in alignment with the client's expressed preference for interpretable, low-complexity system behavior. While AI components may be optionally employed in future iterations for pattern recognition in fraud detection, the current invention prioritizes deterministic rule-based mechanisms for trust and transparency.

The secure profile creation infrastructure disclosed herein thereby forms the foundational trust layer of the platform, ensuring that athlete, coach, and brand identities are accurate, age-appropriate, and safeguarded against manipulation or unauthorized use. By embedding age verification logic, parental consent mechanisms, and structured intake workflows within the architecture, the invention creates a legally compliant and ethically grounded environment for users of varying roles and maturity levels to engage in athletic networking and career development.

The present invention provides a structured digital ecosystem that facilitates interactive engagement and discovery between multiple user classes, including athlete users, coaches and institutional recruiters, and commercial entities such as athletic brands, trainers, and nutrition providers. The system is configured to support direct and indirect interaction workflows between these roles, leveraging structured data inputs, interest-based tagging, and filtered content presentation layers to optimize relevance, transparency, and user experience without reliance on speculative or fully autonomous artificial intelligence systems.

Upon successful profile activation, athlete users may publish a variety of data objects including athletic statistics, preferred positions, schools of interest, uploaded videos, and written narrative elements that describe their training history or competitive experience. This structured data is stored in a profile metadata model, enabling downstream filtering, browsing, and querying by other system users. Institutional users, such as coaches and recruiters, create program-centric profiles highlighting team needs, recruitment priorities, school characteristics, and competitive level, thereby allowing athletes to discover and engage with programs that align with their academic and athletic goals.

Commercial users, including retailers, performance trainers, and nutrition providers, participate in the system through brand-oriented profile creation that supports outbound marketing and inbound discovery. Brand profiles may include product offerings, service descriptions, athlete sponsorship opportunities, and engagement campaigns targeted toward specific demographic cohorts or sport types. These brand entities may be surfaced to athlete users through targeted content feeds and search results, provided that the athlete's profile attributes fall within the brand's declared targeting parameters.

The interaction model is governed by a bidirectional discovery framework. Athlete users may search for schools or brands using a guided query interface, featuring filters such as geographic location, sport type, competition level, and institution size. Similarly, coaches may initiate structured queries against the athlete profile database using predefined filters for performance metrics, position, graduation year, and expressed interest in specific institutions. While the underlying matching is executed via structured metadata comparisons and deterministic logic, the system may optionally deploy lightweight AI-driven scoring models to surface athletes or coaches with similar engagement patterns, mutual interests, or aligned behaviors, provided such models are limited in scope and transparent in methodology.

Communication between users is gated by role-specific permissions and system-defined privacy conditions. For example, athlete-to-athlete messaging may be unrestricted, whereas direct athlete-to-coach communication may be contingent upon a mutual engagement event, such as a profile view, saved search result, or explicit “connect” action. Retailer communication pathways are regulated by consent frameworks, ensuring that promotional messages or branded interactions are only enabled where an athlete user has either expressed interest in the brand category or has not opted out of such engagements. This layered permissions model is designed to prevent unsolicited communication, preserve user agency, and support compliance with data protection and marketing regulations.

To facilitate ongoing discovery and engagement, the platform implements a passive surfacing mechanism through which relevant users and profiles are promoted in a user's interface based on their activity and profile composition. For instance, an athlete who uploads a highlight video tagged with “midfield,” “soccer,” and “California” may be surfaced to coaches whose program preferences include those attributes. While these surfacing actions may be influenced by basic AI recommendation logic in one embodiment, they are always bounded by rule-based eligibility criteria and explicit profile declarations to ensure deterministic outputs, consistent with the platform's design emphasis on transparency and user comprehension.

The disclosed interaction architecture balances user discovery, connection, and privacy through a combination of structured metadata, user-declared interests, filtered queries, and light algorithmic prioritization. By avoiding opaque or probabilistic decision-making systems at this stage, the invention maintains interpretability, user trust, and alignment with the client's preference for launching a version of the platform that emphasizes real, verified connection over speculative automation. Future iterations may build upon this infrastructure to support advanced matchmaking or behavioral insights, but the present invention maintains fidelity to a conservative, structured discovery paradigm optimized for athletic career advancement and brand engagement.

The present invention includes a robust content sharing and media engagement framework, designed to facilitate the exchange of user-generated content across the platform's diverse user roles. This system architecture supports multimedia content uploads, structured post creation, interactive engagement, and controlled visibility settings, all within the context of athlete development, recruitment outreach, and brand promotion. Unlike traditional static-profile platforms, the invention enables dynamic and contextually relevant content flow through time-based feeds, role-specific post types, and media playback functionality embedded directly within the user interface.

Athlete users are empowered to upload and share various forms of content, including but not limited to gameplay footage, practice recordings, commentary, training regimens, performance updates, and achievement milestones. The platform accepts media in multiple standard formats and converts all uploaded assets through a media normalization pipeline, which transcodes, compresses, and indexes the content to ensure compatibility, responsive delivery, and efficient retrieval. Each media upload is automatically associated with metadata tags derived from both user input (e.g., “position,” “event type,” “location”) and system-inferred values based on the content's filename, submission context, or previously declared profile attributes.

Upon upload, media assets are stored in a secure content management subsystem (CMS) that supports encrypted storage, structured indexing, and access logging. The CMS integrates with the user interface to provide inline video playback, content thumbnails, and comment-enabled display windows. All interactions with media—such as views, likes, and comments—are captured in engagement logs, which are used to populate activity feeds and inform optional recommendation surfaces. Notably, the system does not engage in computer vision-based analysis of video content at this stage, in accordance with client direction to exclude speculative AI processes. However, the media handling framework is architected to accommodate such extensions in future embodiments, including the potential for computer vision tagging, scene segmentation, or gesture recognition if such features become commercially viable and contractually supported.

In addition to video, users may author and post written content, including narrative updates, recruitment announcements, training progress, or endorsements of other users or organizations. These posts may be augmented with images, hashtags, and tagged users to facilitate broader reach and topical organization. Each post is associated with a timestamp and user ID, and the system provides moderation tooling, both automated and manual, to enforce compliance with community standards. The automated moderation layer includes lightweight keyword detection models for flagging posts with potentially inappropriate or offensive language. These models utilize basic natural language processing (NLP) techniques limited to deterministic phrase matching and soft rule evaluation, intentionally avoiding opaque deep learning or sentiment inference models to preserve clarity, control, and explainability.

All user roles are provided with functionality to engage with content in-platform, subject to permission structures based on role compatibility and user preferences. Athletes may comment on peer posts, react to brand content, or respond to coach-generated updates. Coaches may save athlete content to personalized watchlists, share internally within a recruiting team, or initiate engagement via predefined communication workflows. Brands may promote content tagged with their name, sponsor athlete updates, or respond to engagement metrics through targeted outreach if permitted. The system maintains detailed audit trails of all interactions, enabling both performance tracking and compliance monitoring.

The content feed is rendered algorithmically based on recency, declared interests, prior engagement, and optionally, basic collaborative filtering. Such filtering employs lightweight similarity scoring across user behavior vectors—such as shared likes, mutual views, and post topic overlap—to suggest potentially relevant users or content items. These algorithmic decisions are rule-bound, interpretable, and always capable of being overridden or hidden by the user. This implementation approach reflects the client's directive to integrate AI in a supportive, transparent manner, while avoiding full reliance on predictive modeling or black-box ranking systems in the MVP release.

Collectively, the content sharing and engagement system provides users with a rich, interactive, and multimedia-enabled experience that supports visibility, connection, and communication across user roles. It prioritizes content authenticity, moderation integrity, and user control, while preserving extensibility for future incorporation of more advanced AI functionalities when warranted by user demand and operational readiness.

The present invention further includes a modular framework for algorithm-assisted discovery and structured user search, designed to facilitate meaningful connections between athletes, coaches, institutional recruiters, and affiliated commercial entities. Unlike advanced artificial intelligence (AI) systems that rely on opaque machine learning models and probabilistic inference, the matching and search functionalities disclosed herein are grounded in deterministic logic, user-declared parameters, and optional lightweight algorithmic enhancements which are fully transparent and rule-based in nature.

At the core of the platform's discovery functionality lies a multi-tiered filtering engine that indexes user profile metadata and content descriptors into a query-optimized schema. Each user—whether an athlete, coach, or commercial profile—may specify a range of discovery preferences, including but not limited to sport type, position, graduation year, geographic location, institution size, competition level, product interest category, or training discipline. These structured preferences are stored in relational data models, facilitating bidirectional lookup across user classes through explicit parameter-based matching.

Athletes, for example, may query the platform to identify academic programs that align with their performance tier and regional preferences. Conversely, coaches may execute queries to surface athlete profiles that meet specific recruitment criteria, such as verified statistics, sport-specific roles, or previous engagement with institutional content. The search engine enables refinement through a hierarchical filter interface, allowing users to iteratively narrow or broaden results. Additionally, saved searches and query templates may be defined by users for future use, enabling periodic notifications or digest-style results as new users matching those criteria onboard to the platform.

To complement this explicit matching system, the invention optionally incorporates a lightweight recommendation engine that utilizes basic collaborative filtering and rule-based logic to suggest content or connections that align with inferred user interest. For example, if a coach frequently views and bookmarks athlete profiles from a specific region or league, the system may increase the visibility of similar profiles in future content feeds. These recommendations are computed using interpretable similarity metrics—such as shared profile tags, overlapping filter parameters, or mutual post engagement—and do not rely on unsupervised machine learning or deep learning classification models.

Importantly, the invention supports full user override of all recommendation and visibility settings. Athlete users may opt out of being surfaced in passive discovery feeds or suppress connection suggestions from non-targeted user roles. Coaches and institutions may toggle the visibility of recruitment preferences, controlling whether their search criteria contribute to content matching. Commercial users are limited to predefined interaction channels and may not trigger unsolicited discovery unless the athlete user has explicitly consented to brand exposure or opted into sponsored content streams.

Platform governance is maintained through a centralized policy enforcement layer, which defines system behavior related to privacy, visibility, recommendation logic, and communications. This layer includes administrative controls for managing content moderation flags, abuse reports, and violations of the honor code or user terms of service. While the system's default behavior is driven by static policy definitions and procedural logic, optional audit tooling may employ simple anomaly detection techniques—such as threshold exceedance or frequency-based flags—to alert system moderators to potentially abusive behavior. However, in keeping with the design philosophy of interpretability and control, such tools are never autonomous; they serve only as triage mechanisms for human-led intervention.

All system activity relevant to discovery, matching, and governance is logged through immutable audit records, ensuring transparency, traceability, and regulatory defensibility. Logs include query submissions, recommendation engine decisions, user toggles, opt-in/opt-out actions, and administrative overrides. These records may be periodically reviewed by internal compliance staff or exposed to users in summarized form through an account history interface.

In aggregate, the platform's approach to algorithm-assisted interaction respects the balance between user empowerment and computational efficiency. By implementing controlled, explainable, and consent-driven algorithms, the invention advances user connectivity while preserving the human-centric design and ethical governance standards prioritized by the client. It lays the groundwork for future intelligent systems while retaining full compatibility with the platform's MVP-level capabilities and compliance obligations.

It is further noted that, in contrast to prior drafts or broader conceptual frameworks, the present invention intentionally omits any reliance on autonomous software development modules, source code generation systems, or AI-driven bug detection frameworks. No source code is disclosed in this specification, as the invention pertains strictly to the structure, logic, and interaction models of a role-based athlete networking platform as described. Where AI is mentioned, it refers exclusively to deterministic, rule-governed, and interpretable functions intended to support discovery and moderation, and not to high-complexity predictive modeling or system-building automation.

### DETAILED DESCRIPTION OF FIGURES

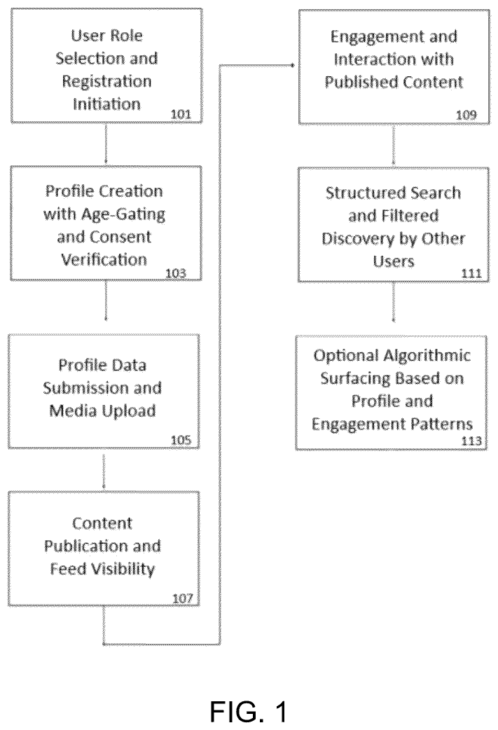

### FIG. 1.101—User Role Selection and Registration Initiation

The process begins with a registration module in which the user is prompted to select a role from among predefined categories, including athlete, coach, institutional representative, or commercial brand entity. The selected role determines the subsequent onboarding workflow, profile field requirements, and access permissions. The system initiates authentication setup, email validation, and assigns a temporary user ID pending completion of the account setup sequence.

### FIG. 1.103—Profile Creation With Age-Gating and Consent Verification

Following role selection, the user is guided through a profile creation interface in which personal, demographic, and role-specific data are collected. For athlete users, if the declared age is below a predetermined threshold (e.g., under 14 years), the system automatically suspends account activation and initiates a parent or guardian co-creation workflow. This includes digital consent, verification of identity, and assignment of parental oversight rights before proceeding.

### FIG. 1.105—Profile Data Submission and Media Upload

Upon completion of verification or consent steps, the user submits structured data to populate their profile, including sport type, position(s), self-reported performance metrics, preferences, and optionally, multimedia files such as gameplay videos and photographs. The system processes uploaded media through a normalization pipeline, which includes format standardization, compression, tagging with metadata, and secure storage in the platform's content management subsystem.

### FIG. 1.107—Content Publication and Feed Visibility

Once the profile is fully populated and verified, the system enables content publication through a time-ordered feed architecture. Users can post written updates, video content, and images, each of which is associated with role-based visibility settings. Published content is displayed within the platform's interface to users with matching permission scopes, including connections, followers, or role-eligible discovery users.

### FIG. 1.109—Engagement and Interaction with Published Content

Other users may interact with published content through a structured engagement layer that includes view tracking, likes, comments, saves, and optional direct communication where permitted. Each interaction is logged and stored for auditing, analytics, and future personalization. Role-based restrictions govern who may comment or initiate communication, in accordance with privacy settings and platform policy.

### FIG. 1.111—Structured Search and Filtered Discovery by Other Users

The platform includes a discovery engine that allows users to perform filtered searches using attributes such as sport, location, graduation year, institution type, position, and content type. This search functionality is executed through an indexed query interface with multi-level filters, allowing users to identify relevant profiles or content using deterministic logic without predictive modeling. When users create profiles, they may create a “handle” i.e., @username or the search may only be by name.

### FIG. 1.113—Optional Algorithmic Surfacing Based on Profile and Engagement Patterns

The system optionally employs lightweight algorithmic logic to surface relevant profiles or content based on activity signals, mutual engagement, or declared interests. This functionality uses rule-based pattern recognition and similarity scoring—such as shared tags, frequent interactions, or geographic overlap—and provides visibility enhancements in user feeds. All algorithmic suggestions are governed by user-defined preferences and may be disabled at any time. Additionally, AI filters can be applied an AI filter that will disallow irrelevant content, e.g., cats riding on skateboards.

What is claimed is:

1. A system for facilitating athlete profile creation, discovery, and engagement within a digital platform for athletes, the system comprising:
a. a role-based registration module configured to create and manage distinct user accounts for athlete users, coach users, institutional representatives, and brand-affiliated commercial users;
b. a secure profile creation interface configured to collect, validate, and store user-provided data, including sport type, position, performance statistics, media uploads, and declared interests;
c. an age-gating subsystem configured to detect users under a predetermined age threshold and enforce a parent-or guardian-mediated co-creation workflow for account activation;
d. a media management module configured to receive, process, transcode, and store user-uploaded video and image content, and to associate such content with user profiles via metadata tagging;
e. a content interaction layer configured to allow users to post multimedia content, and to engage with such content through structured feedback tools including likes, comments, and follows, subject to role-based permissions;
f. a discovery engine configured to facilitate user-to-user and user-to-entity discovery via structured search filters, including sport-specific attributes, geographic criteria, institutional type, and user-declared preferences; and
g. an algorithm-assisted recommendation layer configured to optionally suggest content or user profiles based on rule-based filtering, profile similarity metrics, and engagement patterns, without reliance on opaque predictive models.

2. The system of claim 1, wherein the age-gating subsystem is further configured to require digital consent from a verified parent or guardian prior to activating an athlete account for users under the age of fourteen.

3. The system of claim 1, wherein the media management module includes a transcoding and normalization pipeline that converts uploaded content into a standardized format optimized for cross-platform playback and search indexing.

4. The system of claim 1, wherein the discovery engine includes a hierarchical query interface allowing for multi-level filter refinement and saved search templates.

5. The system of claim 1, wherein the content interaction layer further comprises community standards enforcement through keyword-based filtering and moderation tools configured to detect potentially inappropriate language.

6. The system of claim 1, wherein each user profile is associated with a role-based access model that governs visibility, communication privileges, and content posting capabilities.

7. A method for enabling user-driven connection and content engagement in a digital athletic platform, the method comprising:
a. registering a user account with a role selected from a group consisting of athlete, coach, institution, and brand;
b. receiving profile data including sport type, user biography, statistics, media content, and declared preferences;
c. determining whether the user is under a predetermined age threshold and, if so, initiating a co-creation workflow requiring parental authorization;
d. allowing the user to upload video or image content and associating such content with structured metadata;
e. displaying said content through a content feed interface accessible by other users subject to permissions;
f. enabling other users to engage with the content through predefined actions including viewing, liking, commenting, or bookmarking; and
g. optionally surfacing user profiles or content to others based on deterministic recommendation logic tied to engagement history and profile similarity.

8. The method of claim 7, wherein the metadata associated with content includes user-declared tags and automatically inferred attributes from the upload context.

9. The method of claim 7, wherein the recommendation logic is constrained to interpretable, rules-based processing and excludes the use of autonomous machine learning models.

10. The method of claim 7, wherein user engagement actions are recorded in audit logs for compliance and transparency purposes.
